(19) United States
(12) Patent Application Publication
(10) Pub. No.: US 2004/0263619 A1
(43) Pub. Date: Dec. 30, 2004

(54) Container inspection machine

(76) Inventor: Richard D. Diehr, Horseheads, NY (US)

Correspondence Address: Spencer T. Smith, Emhart Glass Research, Inc., 89 Phoenix Avenue, P.O. Box 1229, Enfield, CT, 06083-1229, US

(21) Appl. No.: 10/610,421

(22) Filed: Jun. 30, 2003

(51) Int. Cl. H04N 7/18

(52) U.S. Cl. 348/127; 348/86

(57) ABSTRACT

A machine for inspecting a portion of a container which is conveyed to an inspection location. A source of two-color light illuminates a bottle and a beam splitter divides the beam into first and second beams of two-color light. One camera images the beam after one color has been filtered and a second camera images the beam after the second color has been filtered.

The present invention relates to machines which inspect bottles for defects and more particularly to a system for inspecting the bottom of a bottle for defects.

### BACKGROUND OF THE INVENTION

Machines for inspecting glass bottles and the like are performing more and more inspections using camera technology. One of the areas of interest is the base or top of a bottle and a system may look at the base or top as an opaque or transparent object to identify defects.

### OBJECT OF THE INVENTION

It is an object of the present invention to provide a machine for inspecting glass containers which can, at a single inspection station conduct a pair of different inspections for defects in the a bottle.

Other objects and advantages of the present invention will become apparent from the following portion of this specification and from the accompanying drawings which illustrate, in accordance with the mandate of the patent statutes, a presently preferred embodiment incorporating the principles of the invention.

### BRIEF DESCRIPTION OF THE DRAWINGS

FIG. 1 is an oblique view of a system for inspecting the bottom of a bottle for defects which has two cameras;

FIG. 2 is a view of a portion of the image of one of the cameras which indicates a defect; and

FIG. 3 is a view of the same portion of the image of the other one of the cameras which indicates the same defect.

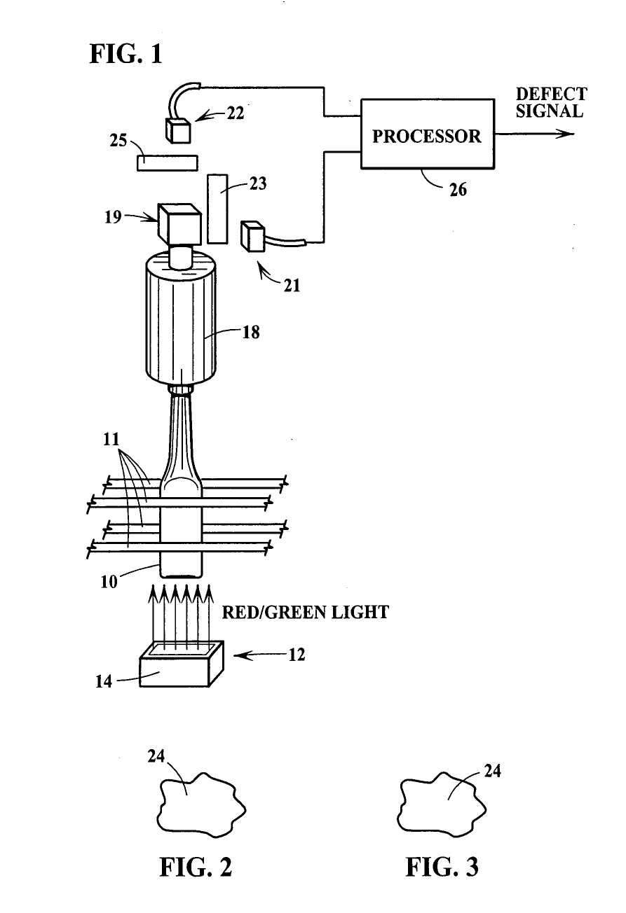

### BRIEF DESCRIPTION OF THE PREFERRED EMBODIMENT

A single camera lens, dual camera imaging system is illustrated. A bottle 10 is being carried through an inspection machine by a belt type drive which may have upper and lower belts 11 engaging the front and rear wall of the bottle. The belt type drive removes a bottle from an infeed conveyor, conveys the bottle through an inspection location and then releases the bottle to an outfeed conveyor. An inspection system is located at the inspection location and includes a light source assembly 12 which includes a light source 14 which directs light axially upwardly through the bottle. While in this embodiment the bottom of the bottle is inspected, the top of the bottle (the sealing surface, for example, could also be inspected.

The camera assembly includes a lens 18 which directs the light to a beam splitter 19 and a pair of cameras 21,22 which image each of the beams. Light passes through the bottom of the bottle upwardly through the opening of the bottle to the beam splitter and images the bottom of the bottle on the image plane of the first camera 21.

The light source has two different colors, for example red and green. The beam splitter splits the beam and sends the red and green light to both cameras. In front of one camera would be a red filter 23 to filter out the red light and in front of the other camera would be a green filter 25 to filter out the green light. The red light could appear as bright light and FIG. 2, illustrates how an inclusion 24 might appear to the camera seeing red light. The green light could appear as darkness and FIG. 3, illustrates how an inclusion 24 might appear to the camera seeing the green light.

The image of each camera is evaluated periodically by a Processor 26 and a suitable defect signal will be issued when a defect is detected.

1. A machine for inspecting a portion of a container which is conveyed to an inspection location comprising
a source of two color light for illuminating a bottle,
a camera system for imaging the illuminated bottle including
a first camera,
a second camera, and
a beam splitter for directing the two colored light to said first camera and for directing the two colored light to said second camera,
a first filter intermediate said first camera and said beam splitter for removing one of the light colors and
a second filter intermediate said second camera and said beam splitter for removing the second one of the light colors.

2. A machine for inspecting a container according to claim 1, wherein the portion of the bottle inspected is the bottom of the container.

3. A machine for inspecting a container according to claim 1, wherein the two light colors are green and red.
